(19) United States
(12) Patent Application Publication
(10) Pub. No.: US 2020/0309542 A1
(43) Pub. Date: Oct. 1, 2020

(54) Method for the Simultaneous Localization and Mapping of a Mobile Robot

(71) Applicant: Robert Bosch GmbH, Stuttgart (DE)

(72) Inventors: Florian Haug, Ditzingen (DE); Markus Ferch, Beilstein (DE); Sheung Ying Yuen-Wille, Leonberg (DE); Stefan Leibold, Talheim (DE); Torsten Scherer, Tuebingen (DE); Yorck Von Collani, Beilstein (DE); Thilo Grundmann, Ludwigsburg (DE)

(21) Appl. No.: 16/825,056

(22) Filed: Mar. 20, 2020

(30) Foreign Application Priority Data
Mar. 29, 2019 (DE) 10 2019 204 410.7

(51) Int. Cl. G01C 21/32; G05D 1/02

(52) U.S. Cl. CPC G01C 21/32; G05D 1/0236; G05D 1/0274

(57) ABSTRACT

A method for the simultaneous localization and mapping of a mobile robot includes optimizing via compensation transformations in the detection of already mapped structures. A compensation transformation is performed during the mapping on the basis of an identification of at least one stationary marker. The compensation transformation is performed with an already existing position of the at least one stationary marker from a preceding mapping and in the event of a deviation in the position of the at least one stationary marker in a current mapping. An electronic control unit in one embodiment is configured to execute the method.

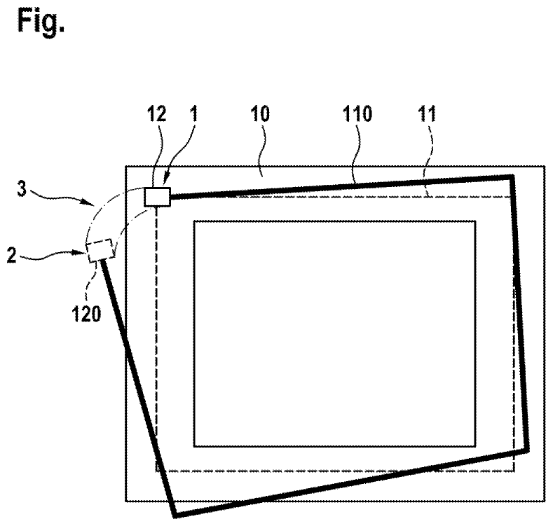

This application claims priority under 35 U.S.C. § 119 to patent application no. DE 10 2019 204 410.7, filed on Mar. 29, 2019 in Germany, the disclosure of which is incorporated herein by reference in its entirety.

### BACKGROUND

The present disclosure relates to a method for the simultaneous localization and mapping of a mobile robot, wherein the simultaneous localization and mapping comprises an optimization step through compensation transformations in the detection of already mapped structures. The disclosure furthermore relates to a computer program to carry out the method and a corresponding machine-readable storage medium and an electronic control unit.

In the mobile robotics domain, it is known that a mobile robot creates a map of its environment and simultaneously estimates its position within this map. Algorithms which determine the position of the autonomous robot relative to its environment are used for this simultaneous localization and mapping (SLAM). An environment representation, i.e. a map, is created on the basis of on-board sensors of the mobile robot, said map incorporating the physical characteristics of the environment detectable by means of the available sensors, such as, for example, a laser scanner, camera, radar, ultrasound, etc., in connection with the. These SLAM algorithms are already used outside the mobile robotics domain also, for example in fields of application which involve unmanned aircraft (drones), autonomous motor vehicles, automated industrial trucks, etc.

The SLAM process is generally divided into four steps:

a. The relative position change of the robot is estimated on the basis of the previous position of the robot in the already created map and the sensor values stored in the map, if necessary with the aid of further sensors. At the beginning of the process, an initial position of the robot can be assumed, wherein an individual initial set of sensor values can be present at the beginning of the process. The further sensors which can be used to estimate the relative position change can be implemented, for example, on the basis of an inertial measuring unit (IMU), a radodometry, an optical flow, etc.

b. On the basis of this estimation position, the sensor values are compared with the sensor values stored in the map and are checked for a possible local correspondence (matching). The aim here is to achieve the highest possible matching of already observed environment features stored in the map and the environment features similarly detected in the current sensor value set. The current sensor values are inserted to a certain extent seamlessly into the map (mapping) at the point of maximum matching.

c. The current vehicle position relative to the map is then corrected on the basis of this insertion point in the map (localization). This position can then be used as a starting point (new initial position) for the next iteration.

d. In an optional optimization step, it is investigated whether additional correspondences can be found between the current sensor values and other map areas. If an environment feature observed in the current sensor value set recurs at a different point in the map, a matching is carried out here also. If this match satisfies a certain quality criterion, the local difference between the two positions is compensated over all insertion points of the sensor value sets contained in the map by means of an optimization algorithm or a compensation transformation so that the sensor values which describe one and the same environment feature spatially match each other. This step is also referred to as loop closure.

### SUMMARY

The present disclosure proposes a method for the simultaneous localization and mapping of a mobile robot, wherein an optimization step is carried out through compensation transformations during the detection of already mapped structures. The proposed method allows a substantially simpler and more robust detection and handling of loop closures which can be carried out with computing time optimization. The essence of the method is that the compensation transformation is carried out during the mapping on the basis of an identification of at least one stationary marker in that the compensation transformation is performed with an already existing position of the at least one stationary marker from a preceding mapping in the event of a deviation in the position of the at least one stationary marker in a current mapping. An augmentation of the loop closure detection and a particularly robust map creation are possible through the incorporation of a marker detection system into the SLAM method. The only requirement for the marker detection system here is that the detection system is able to uniquely identify a stationary marker and to determine its position relative to the robot. In this respect, any form of active or passive marker system which can uniquely identify a signature or a different characteristic of a marker and which allows the derivation of relative repeatable position information for the robot on this basis can, in principle, be used for this purpose. The respective marker positions can be annotated in the map during the SLAM process on the basis of the unique identifiability of the marker or, where appropriate, markers by the detection system and the position information obtained therefrom. As soon as a marker which is already stored in the map is detected, a corresponding compensation transformation, i.e. a loop closure, can be carried out on the basis of the current robot position relative to the marker if the current position of the marker deviates from an already mapped position.

The expression “loop closure” is used below in the sense that a compensation transformation is carried out in the event of local differences of positions in the current mapping in relation to positions from preceding mappings.

The performance of compensation transformations or loop closures of this type generally offers the advantage that a check can be carried out from the perspective of the robot to determine whether it has already been at the location before and has to some extent already seen this part of the environment before. If so, a check is carried out from the perspective of the robot to determine whether the information from the already existing mapping matches this information. In a perfect system with a perfect position estimation, a check and optimization of this type would not be necessary since, in a perfect system, the robot position in the map would always correspond to the robot position in the real environment. However, different error sources are present in a real system (e.g. drift in the inertial measuring unit, a slippage of the radodometry, sensor noise, discretization errors in the matching, etc.) so that the sum of the different error sources results in a drift in the robot position and a distortion of the map. In the worst case, as a result of the drift in the robot position to be observed in real systems and the distortion of the map, in the case of a closed circle or a closed rectangle as the movement path of the robot, for example in the case of an aisle following a corresponding course, the end point of the aisle does not coincide with the starting point. It is therefore important for the functionality of the SLAM process that the end point of the mapping which simultaneously represents the starting point of the mapping is also recognized as such and that, if necessary, corresponding compensation transformations are carried out as loop closures. Conventional systems operate on the basis that features are extracted from the available sensor data and that these features are compared with the data stored in the map. However, substantial computing power is required for this purpose, and for this reason conventional SLAM systems need to be equipped with correspondingly high-performance hardware. The SLAM process cannot otherwise be performed in real time. The proposed method gets by with substantially less computing power since it relates to the identification of a stationary marker. The hardware requirements to carry out the proposed method are therefore significantly less than in the case of conventional methods.

The proposed method furthermore offers the advantage that no false-positive results can occur in the detection of loop closures. This problem occurs relatively frequently in conventional methods since, particularly in artificial environments such as buildings, identical aisles or building wings often occur so that no unambiguous statement regarding the current vehicle position can be made on the basis of the sensor data since, for example, an aisle A cannot be distinguished by the sensors from an aisle B. The robot could therefore to some extent assume that it has already been at a corresponding position before and could carry out a corresponding compensation transformation as a loop closure. This false-positive result can create erroneous or even unusable maps. This problem cannot occur in the proposed method, since the stationary markers are uniquely identifiable and do not produce false-positive results.

In one preferred design of the proposed method, a position of the robot relative to the at least one stationary marker is determined. The position of the stationary marker can be inferred from this relative position so that any necessary compensation transformation can be carried out according to the proposed method. It is therefore not necessary for the absolute position of the stationary marker to be known. The position of the marker relative to the robot alone is already sufficient. It is therefore not necessary to calibrate the stationary marker(s) in advance in a time-consuming and costly manner. The only prerequisite is simply that the position(s) of the marker(s) is/are stationary and does/do not change during the mapping.

All conventional and available detection systems can, in principle, be envisaged as detection systems. Optical marker detection systems, for example, and/or radio-based location systems and/or near-infrared-based camera motion tracking systems and/or location systems based on ultrasound or radar can be used. Optical marker detection systems can be used in a particularly simple and practicable manner, wherein the at least one marker is an optical marker and wherein at least one camera is provided on or at the mobile robot so that the optical marker(s), for example a barcode, a QR code or the like, can be detected and identified by means of the camera(s). In other designs, the identification of the stationary marker can be carried out, for example, on the basis of a laser system, wherein the at least one marker can be a passive-reflecting marker or an active laser source. The detection counterpart on the robot is designed accordingly, depending on the marker type. A passive-reflecting marker may, for example, be a laser system on the robot or simply a laser detection system if the marker itself is an active laser source. The detection system(s) on the mobile robot can also be designed in such a way that active ultrasound or radar markers (beacons) can be located. Other systems can be based on near-infrared, enabling a position determination using active markers (e.g. infrared light sources) or passive markers (e.g. reflectors).

Radio-based location systems can be used to particular advantage. UWB (ultra wideband), for example, RFID (radio-frequency identification) or the like can be used for this purpose. One or more access points of a WLAN structure or of a mobile radio infrastructure can be used to particular advantage as stationary markers. Already existing structures, in particular, which are used as stationary markers in the sense of the proposed method can also be used for this purpose. The position of the robot relative to the markers can be determined in a particularly preferred manner, for example, by means of an evaluation of a transit time measurement in relation to two or more access points, for example of a WLAN structure. The relative position of the stationary marker(s) can be inferred from this relative position so that a check can be carried out on the basis of this information to determine whether a deviation is present in the position of the stationary markers if the current mapping is compared with a previous mapping so that, if necessary, a compensation transformation can be carried out. The distance or the direction of individual markers can be determined by means of a transit time measurement. A position determination can furthermore be carried out through trilateration or triangulation in the case of a plurality of markers or a plurality of measurements of an individual marker from different positions. Furthermore, in the case of a plurality of access points, for example, the access point with the highest receive quality can be identified and can be used as a stationary marker as a basis for the compensation transformation according to the proposed method. An existing mobile radio infrastructure, for example, can be used in a comparable manner instead of a WLAN infrastructure.

It is furthermore particularly advantageously possible to limit the search for already existing positions of the stationary marker in a previous mapping to an area of the mapping corresponding to a range of the marker or access point. Computing capacity and/or computing time can be saved as a result. Thus, for example, in the case of a WLAN infrastructure with a plurality of access points, only the access point with the highest receive quality, normally the nearest access point, can be annotated with its hardware identity in the map or mapping. If the access point comes within range again during the subsequent mapping, the already mapped position of the marker needs to be searched for only within a certain area of the mapping or the created map which, for example in the form of a circular area with the radius which corresponds to the range of the access point. It is furthermore possible, for example, for the mere presence of a marker within the receive range to be used as a trigger for a “proximity search” for loop closures in a spatially limited area of the map corresponding to the range of the access point or generally to the visual range of the stationary marker, as a result of which the requirements for computing capacities can be substantially reduced or computing capacities can be saved.

It can be provided that the proposed method is employed using stationary markers only for the mapping and not for a pure localization operation of the mobile robot. The map created in the SLAM process or the already completed mapping can then be used for the pure localization operation without further adaptations of the mapping being carried out. The markers are therefore used only for the mapping in the SLAM process and not for the subsequent localization. In this respect, the stationary markers are then no longer required and can be removed after the actual mapping or can be used for other purposes. In addition, this procedure has the particular advantage that any expended markers do not need to be renewed. The stationary markers which are used for the proposed method can thus to some extent be temporary markers which are used only for mapping purposes and are no longer required for a subsequent pure localization operation of the mobile robot. No permanent infrastructure measures are thus required in order to carry out the proposed method. As mentioned, however, permanent infrastructure measures, such as, for example, WLAN access points which, for example, are present in any event, can also be used particularly advantageously for the proposed method. However, only temporarily used stationary markers, such as, for example, optical markers, can be used for mapping purposes in the SLAM process. Marker technologies, for example, which are less suitable for a comprehensive permanent installation, for example due to high procurement costs, high installation or maintenance costs and/or due to high energy consumption, can thus be used. Markers of this type, for example ultrasound or radar markers, which are used for the purposes of the proposed method can be used, for example, only in the initial period of the operation of a mobile robot for the SLAM process according to the proposed method. As soon as the system has completed the necessary SLAM process, the markers can, if necessary, be removed once more and/or can be used elsewhere.

The disclosure further comprises a computer program which is configured to carry out the steps of the proposed method. The disclosure further comprises a machine-readable storage medium on which a computer program of this type is stored, and an electronic control unit which is configured to carry out the proposed method.

### BRIEF DESCRIPTION OF THE DRAWING

Further features and advantages of the disclosure can be found in the following description of example embodiments in conjunction with the drawing. The individual features can be implemented in each case separately or in combination with one another.

In the drawing, the FIGURE shows a schematic scenario illustrating a loop closure according to the proposed method.

### DETAILED DESCRIPTION

The FIGURE illustrates an example of a scenario illustrating the proposed method. An aisle 10 is shown which runs in a closed rectangle. The dotted line 11 illustrates the real movement path of a mobile robot in the aisle 10. The mobile robot moves in the aisle on the basis of a simultaneous localization and mapping (SLAM), wherein the robot determines its position relative to its environment and simultaneously creates a mapping of the environment based on sensor values for detectable physical characteristics. A drift error occurs in practice due to various error sources, so that the movement path 110 traced by the robot deviates from the real movement path 11. In particular, the starting point 1 of the robot does not match the end point 2. This drift error is compensated by a compensation transformation 3, wherein this compensation transformation 3 is carried out according to the proposed method on the basis of an identification of a stationary marker 12. If the mobile robot therefore passes through the aisle system 10 and returns to the point at which it started, it detects and identifies the marker 12. However, the position of the stationary marker 12 detected at the end point 2 differs from the original position at the start 1 due to the drift error which is more or less inevitable in practice, so that the mobile robot sees the marker at the end point 2 at the position 120. To compensate this drift error, a compensation transformation 3 is carried out according to the proposed method in order to match the end point 2 with the starting point 1 (loop closure). The compensation transformation 3 can be calculated with relatively little computing power on the basis of the actual position of the stationary marker 12.

This proposed method is carried out in connection with a simultaneous localization and mapping of the mobile robot, wherein the robot is itself equipped with a corresponding SLAM system. If necessary, the SLAM system can also be implemented, for example, not directly in the robot, but, for example, on a central computer which is provided to control the mobile robot. The robot is further equipped with a detection device or detection system in order to be able to detect and identify the stationary marker 12. The robot can, for example, be equipped with a camera which can detect the stationary marker, for example an optical marker. In other designs, the robot can be equipped with a laser-based SLAM system. The stationary marker(s) can be implemented in the detection area of the laser system as reflecting markers which can be detected by the laser system that is used. The markers can be uniquely identified and their position determined on the basis of their characteristics, for example a retroreflectivity or the like and/or a spatial arrangement of a plurality of reflex markers in relation to one another. As an alternative to passive reflex markers, active laser light sources, for example, can also be used as markers.

An existing WLAN infrastructure with, for example, a plurality of access points as stationary markers 12 can be particularly advantageously used, wherein a relative position of the robot can be calculated, for example, by means of transit time measurement and trilateration and/or triangulation based on a plurality of access points which are simultaneously within the receive range.

The proposed method can be used for different mobile robotics domains, for example in the intralogistics domain or in production environments. The proposed method can also be used for self-driving vehicles, wherein a high-precision laser localization with camera-marker-based localization systems can be used to detect the stationary markers.

What is claimed is:

1. A method for the simultaneous localization and mapping of a mobile robot, comprising:
optimizing the simultaneous localization and mapping through compensation transformations during the detection of already mapped structures, a respective compensation transformation carried out during the mapping on the basis of an identification of at least one stationary marker; and
performing the compensation transformation with an already existing position of the at least one stationary marker from a preceding mapping and in the event of a deviation in a position of the at least one stationary marker in a current mapping.

2. The method according to claim 1, further comprising:
determining a position of the mobile robot relative to the at least one stationary marker; and
inferring the position of the stationary marker from the determined relative position of the mobile robot.

3. The method according claim 1, wherein the at least one stationary marker is an optical marker that is identified on the basis of an optical marker system, and wherein the mobile robot includes at least one camera.

4. The method according to claim 1, wherein the at least one stationary marker is a passive-reflecting marker or an active laser source that is identified on the basis of a laser system, and wherein the mobile robot includes one or more of at least one laser system and at least one laser detection system.

5. The method according to claim 1, wherein one or more access points of a WLAN structure or a mobile radio infrastructure are used as the stationary markers.

6. The method according to claim 5, further comprising:
determining a position of the mobile robot relative to the stationary markers on the basis of an evaluation of the transit time measurement in relation to two or more access points; and
inferring the position of the stationary markers from the determined relative position of the mobile robot.

7. The method according to claim 5, wherein a plurality of access points are used, and wherein the access point with the highest receive quality is identified and is used as the stationary marker to form the basis for the compensation transformation.

8. The method according to claim 5, further comprising:
limiting a search for already existing positions of the stationary marker from a preceding mapping to an area of the mapping that corresponds to a range of the access point.

9. The method according to claim 1, wherein the at least one stationary marker is not used for a pure localization operation of the mobile robot.

10. A computer program that includes commands configured to cause a computer to execute a method for the simultaneous localization and mapping of a mobile robot, the method including:
optimizing the simultaneous localization and mapping through compensation transformations during the detection of already mapped structures, a respective compensation transformation carried out during the mapping on the basis of an identification of at least one stationary marker, and
performing the compensation transformation with an already existing position of the at least one stationary marker from a preceding mapping and in the event of a deviation in a position of the at least one stationary marker in a current mapping.

11. The computer program according to claim 10, wherein the computer program is stored on a machine-readable storage medium.

12. An electronic control unit for the simultaneous localization and mapping of a mobile robot, the electronic control unit configured to:
optimize the simultaneous localization and mapping through compensation transformations during the detection of already mapped structures, a respective compensation transformation carried out during the mapping on the basis of an identification of at least one stationary marker, and
perform the compensation transformation with an already existing position of the at least one stationary marker from a preceding mapping and in the event of a deviation in a position of the at least one stationary marker in a current mapping.
